(19) United States
(12) Patent Application Publication
(10) Pub. No.: US 2026/0220982 A1
(43) Pub. Date: Jul. 30, 2026

(54) METHOD AND SYSTEM FOR ADVANCED THEFT ALERT

(71) Applicant: Toyota Motor North America, Inc., Plano, TX (US)

(72) Inventors: Brian A. Neu, McKinney, TX (US); Roger J Baker, Frisco, TX (US)

(73) Assignees: Toyota Motor North America, Inc., Plano, TX (US); Toyota Jidosha Kabushiki Kaisha, Toyota-shi Aichi-ken (JP)

(21) Appl. No.: 19/038,205

(22) Filed: Jan. 27, 2025

(51) Int. Cl. G07C 5/04; B60R 16/023; B60R 25/102; B60R 25/32; B60R 25/34

(52) U.S. Cl. CPC G07C 5/04; B60R 16/0231; B60R 25/102; B60R 25/32; B60R 25/34

(57) ABSTRACT

A method may include receiving, at a vehicle system, diagnostic trouble codes (DTCs) from a plurality of electronic control units (ECUs) associated with the vehicle system, determining whether communication has been lost between the vehicle system and one or more of the ECUs, and upon determination that communication been lost between the vehicle system and more than a first predetermined threshold number of the ECUs, transmitting an alert.

### TECHNICAL FIELD

The present specification relates to vehicle systems, and more particularly, to a method and system for advanced vehicle theft alert.

### BACKGROUND

Vehicle theft has become more prevalent in recent years. In particular, three forms of E-theft have become more prevalent: relay attack, CAN injection, and rekey/reprogramming. CAN injection works by accessing an electronic control unit (ECU) of a vehicle and sending malicious directions over the vehicle’s controller area network (CAN) to unlock the vehicle, start the vehicle, and shutdown external communications. Accordingly, a need exists for a method and system for advanced vehicle theft alert.

### SUMMARY

In an embodiment, method may include receiving, at a vehicle system diagnostic trouble codes (DTCs) from a plurality of electronic control units (ECUs) associated with the vehicle system, determining whether communication has been lost between the vehicle system and one or more of the ECUs, and upon determination that communication has been lost between the vehicle system and more than a first predetermined threshold number of the ECUs, transmitting an alert.

In another embodiment, a method may include receiving, at a vehicle system, DTC from a plurality of ECUs associated with the vehicle system, receiving, at the vehicle system, sensor data from one or more vehicle sensors, and determining whether communication has been lost between the vehicle system and one or more of the ECUs. Upon determination that communication has been lost between the vehicle system and more than a first predetermined threshold number of the ECUs, the method may include determining a plurality of driving behaviors or vehicle settings based on the sensor data, determining a first driver profile based on the determined plurality of driving behaviors or vehicle settings, performing a comparison between the first driver profile and a second driver profile, and determining whether the first driver profile matches the second driver profile based on the comparison. Upon determination that the first driver profile does not match the second driver profile, the method may include transmitting an alert.

In another embodiment, a vehicle system may include one or more processors configured to receive DTCs from a plurality of ECUs associated with the vehicle system, receive sensor data from one or more vehicle sensors, and determine whether communication has been lost between the vehicle system and one or more of the ECUs. Upon determination that communication has been lost between the vehicle system and more than a first predetermined threshold number of the ECUs, the one or more processors may determine a plurality of driving behaviors or vehicle settings based on the sensor data, determine a first driver profile based on the determined plurality of driving behaviors or vehicle settings, perform a comparison between the first driver profile and a second driver profile, and determine whether the first driver profile matches the second driver profile based on the comparison. Upon determination that the first driver profile does not match the second driver profile, the one or more processors may transmit an alert.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a schematic diagram of a vehicle system, according to one or more embodiments shown and described herein;

FIG. 2 depicts memory modules of the vehicle system of FIG. 1, according to one or more embodiments shown and described herein;

FIG. 3 depicts example steering angle data that may be analyzed by the vehicle system of FIGS. 1 and 2, according to one or more embodiments shown and described herein;

FIG. 4 depicts example throttle position data that may be analyzed ty the vehicle system of FIGS. 1 and 2, according to one or more embodiments shown and described herein;

FIG. 5 depicts a flowchart of an example method of operating the vehicle system of FIGS. 1 and 2 for performing advanced vehicle theft alert, according to one or more embodiments shown and described herein; and

FIG. 6 depicts a flowchart of another example method of operating the vehicle system of FIGS. 1 and 2 for performing advanced vehicle theft alert, according to one or more embodiments shown and described herein.

### DETAILED DESCRIPTION

The embodiments disclosed herein include a method and system for advanced vehicle theft alert. As discussed above, vehicle theft by CAN injection is becoming more prevalent. This method of vehicle theft involves connecting a device to an accessible ECU of a vehicle. Once the malicious device is connected to the ECU, malicious code on the device transmits a signal to the vehicle system of the vehicle instructing the vehicle system to unlock the doors and to start the vehicle. Once the doors are unlocked and the vehicle is started, a thief can easily steal the vehicle.

In addition to unlocking the doors and starting the vehicle, the malicious code on the device may also instruct the vehicle system to shut down other ECUs that are part of the vehicle system. In particular, the device may instruct the vehicle system to shut down ECUs that communicate with the outside world, so that these ECUs are unable to transmit data that may indicate that the vehicle is being stolen. This may cause multiple ECUs of the vehicle system to be shut down simultaneously or in quick succession.

In embodiments disclosed herein, the vehicle system is able to detect that multiple ECUs are being shut down, and transmits an alert to either a user associated with the vehicle (e.g. a smart phone belonging to the vehicle’s owner) or to a remote server, which may then transmit an alert to the user associated with the vehicle. This may notify the vehicle owner that their vehicle is likely being stolen, and the vehicle owner can contact law enforcement to report the theft.

In addition, in embodiments disclosed herein, a driver profile may be learned for the owner of the vehicle and other authorized users of the vehicle (e.g., friends and family members selected by the vehicle owner). The driver profile may comprise a pattern of behaviors or vehicle settings associated with the vehicle owner (e.g., seat adjustments, mirror positions, climate choices, audio choices, and the like). Each time that a vehicle is driven by a driver, the vehicle system may detect driving behaviors or vehicle settings, and compare these driving behaviors or vehicle settings to a previously learned driver profile. If the driving behaviors or vehicle settings do not match the driver profile, this may indicate that the vehicle is being stolen, and the vehicle system may transmit an alert to the vehicle owner or to an external computing device. In some examples, the vehicle system may determine whether to send an alert based on a combination of one or more ECUs of the vehicle shutting down, and the comparison of the driver’s behavior and settings to the vehicle profile, as disclosed herein.

Furthermore, the embodiments disclosed herein may be useful in other situations besides vehicle theft. For example, if a driver is impaired (e.g., under the influence of drugs or alcohol, or suffering a medical emergency such as a heart attack, a seizure, or a stroke), the driving behaviors of the driver may not match the driver profile, while the vehicle settings may match the driver profile. As such, it may be detected that the driver may be impaired. In some examples, when it is detected that the driver may be impaired, an emergency contact associated with the driver (but not a user of the vehicle) may be notified so that the emergency contact can take appropriate action.

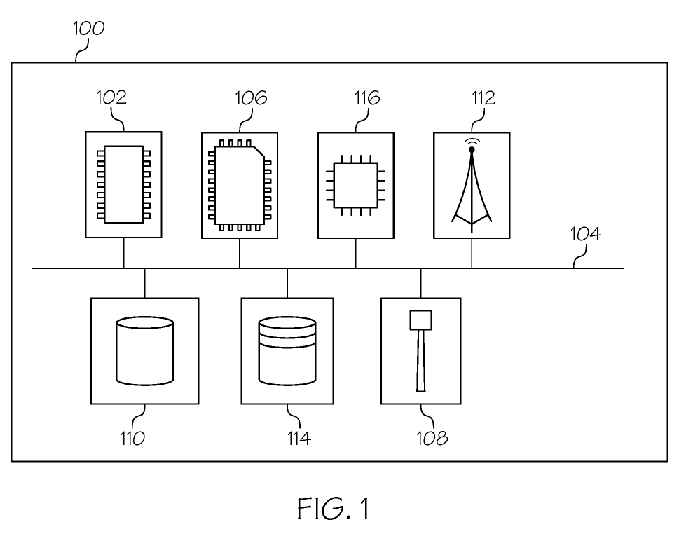

Turning now to the figures, FIG. 1 depicts a vehicle system 100 that may be included in a vehicle. In the example of FIG. 1, the vehicle system 100 includes one or more processors 102, a communication path 104, one or more memory modules 106, a satellite antenna 108, one or more vehicle sensors 110, a network interface hardware 112, a data storage component 114, and one or more ECUs 116, the details of which will be set forth in the following paragraphs.

Each of the one or more processors 102 may be any device capable of executing machine readable and executable instructions. Accordingly, each of the one or more processors 102 may be a controller, an integrated circuit, a microchip, a computer, or any other computing device. The one or more processors 102 are coupled to a communication path 104 that provides signal interconnectivity between various modules of the vehicle system 100. Accordingly, the communication path 104 may communicatively couple any number of processors 102 with one another, and allow the modules coupled to the communication path 104 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 104 may be formed from any medium that is capable of transmitting a signal such as, for example, conductive wires, conductive traces, optical waveguides, or the like. In some embodiments, the communication path 104 may facilitate the transmission of wireless signals, such as Wi-Fi, Bluetooth®, Near Field Communication (NFC) and the like. Moreover, the communication path 104 may be formed from a combination of mediums capable of transmitting signals. In one embodiment, the communication path 104 comprises a combination of conductive traces, conductive wires, connectors, and buses that cooperate to permit the transmission of electrical data signals to components such as processors, memories, sensors, input devices, output devices, and communication devices. Accordingly, the communication path 104 may comprise a vehicle bus, such as for example a LIN bus, a CAN bus, a VAN bus, and the like. Additionally, it is noted that the term "signal" means a waveform (e.g., electrical, optical, magnetic, mechanical or electromagnetic), such as DC, AC, sinusoidal-wave, triangular-wave, square-wave, vibration, and the like, capable of traveling through a medium.

The vehicle system 100 includes one or more memory modules 106 coupled to the communication path 104. The one or more memory modules 106 may comprise RAM, ROM, flash memories, hard drives, or any device capable of storing machine readable and executable instructions such that the machine readable and executable instructions can be accessed by the one or more processors 102. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 106. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Referring still to FIG. 1, the vehicle system 100 comprises a satellite antenna 108 coupled to the communication path 104 such that the communication path 104 communicatively couples the satellite antenna 108 to other modules of the vehicle system 100. The satellite antenna 108 is configured to receive signals from global positioning system satellites. Specifically, in one embodiment, the satellite antenna 108 includes one or more conductive elements that interact with electromagnetic signals transmitted by global positioning system satellites. The received signal is transformed into a data signal indicative of the location (e.g., latitude and longitude) of the satellite antenna 108, and consequently, the vehicle containing the vehicle system 100.

The vehicle system 100 comprises one or more vehicle sensors 110. Each of the one or more vehicle sensors 110 is coupled to the communication path 104 and communicatively coupled to the one or more processors 102. The one or more vehicle sensors 110 may include, but are not limited to, equipment sensors, LiDAR sensors, RADAR sensors, optical sensors (e.g., cameras, laser sensors), proximity sensors, location sensors (e.g., GPS modules), and the like. In embodiments, the vehicle sensors 110 may monitor a variety of vehicle components and vehicle operations, including, for example, vehicle speed, vehicle acceleration, climate settings, audio settings, mirror positions, seat positions, vehicle lighting, driver hand position on the steering wheel, driver eye position and gaze direction, connectivity of accessories, presence of key fob, and the like. Data collected by the one or more vehicle sensors 110 may be utilized by the vehicle system 100 to determine whether transmit an alert, as disclosed in further detail below.

Still referring to FIG. 1, the vehicle system 100 comprises a data storage component 114. The data storage component 114 may store data used by various components of the vehicle system 100. For example, the data storage component 114 may store sensor data collected by the vehicle sensors 110 and/or data associated with driver profiles.

Still referring to FIG. 1, the vehicle system 100 includes one or more ECUs 116 coupled to the communication path 104. Each one of the ECUs 116 may control different components of the vehicle. For example, one ECU 116 may control a lighting system of the vehicle, another ECU 116 may control an audio system of the vehicle, and yet another ECU 116 may control door locks of the vehicle. Each of the ECUs 116 may communicate with the one or more processors 102 via the communication path 104. In particular, the one or more processors 102 may transmit instruction signals to a particular ECU 116 to perform a vehicle operation (e.g., changing the vehicle lights, changing the vehicle temperature, and the like), and the ECU 116 may receive the instruction signals and interact with the appropriate vehicle components to perform the operation specified by the received instruction signals. The ECUs 116 may also transmit information to the one or more processors 102, as discussed below.

In embodiments, the ECUs 116 may transmit diagnostic trouble codes (DTCs) to the one or more processors 102. In particular, each of the ECUs 116 may transmit DTCs indicating a problem or malfunction with one or more vehicle components controlled by the ECUs 116. For example, the ECU 116 responsible for controlling the lighting system of the vehicle may transmit a DTC indicating that one of the headlights is not working. Upon receiving such a DTC, the vehicle system 100 may indicate, to a driver or vehicle owner, the detected component malfunction. For example, the vehicle system 100 may illuminate an instrument panel light or transmit an alert to a user device associated with the vehicle owner (e.g., a smartphone) or to a remote computing device. This may alert the vehicle owner to the problem so that the vehicle owner can take the vehicle to a service technician to repair the problem.

In another example, an ECU 116 may transmit a DTC code to the one or more processors 102 if the ECU 116 is shutting down. Alternatively, the vehicle system 100 may detect that communication has been lost between an ECU 116 and the one or more processors 102 (e.g., if no communications have been received by the one or more processors 102 from the ECU 116 for more than a threshold period of time). If one or more ECUs 116 shut down or lose communication with the one or more processors 102, this indicates that either the vehicle has been damaged in an accident, the vehicle is being serviced by a technician, or a CAN injection vehicle theft has occurred. The vehicle sensors may include sensors that can detect a vehicle crash. As such, the vehicle system 100 is able to determine whether a vehicle crash has occurred. In addition, there are protocols that are typically followed by vehicle technicians to prevent communication loss with the ECUs 116 during service of the vehicle.

Furthermore, if multiple ECUs 116 shut down or lose communication simultaneously or in quick succession, it is even more likely that a CAN injection vehicle theft has occurred. As such, if one or more ECUs 116 shut down or lose communication with the one or more processors 102, the vehicle system 100 may transmit an alert to a vehicle owner or a remote computing device, as disclosed in further detail below. In some examples, the vehicle system may determine whether to send an alert based on losing communication with one or more of the ECUs 116 in combination with data received by the vehicle sensors 110, as disclosed in further detail below.

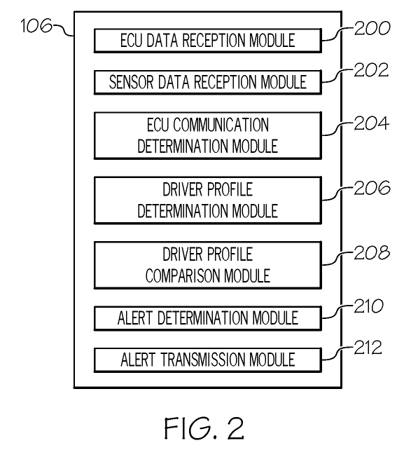

Now referring to FIG. 2, the one or more memory modules 106 of the vehicle system 100 include an ECU data reception module 200, a sensor data reception module 202, an ECU communication determination module 204, a driver profile determination module 206, a driver profile comparison module 208, an alert determination module 210, and an alert transmission module 212. Each of the ECU data reception module 200, the sensor data reception module 202, the ECU communication determination module 204, the driver profile determination module 206, the driver profile comparison module 208, the alert determination module 210, and the alert transmission module 212 may be a program module in the form of operating systems, application program modules, and other program modules stored in the one or more memory modules 106. In some examples, the program module may be stored in a remote storage device that may communicate with the vehicle system 100. Such a program module may include, but is not limited to, routines, subroutines, programs, objects, components, data structures and the like for performing specific tasks or executing specific data types as will be described below.

The ECU data reception module 200 may receive data from the ECUs 116. As discussed above, the one or more processors 102 may communicate with the ECUs 116 by transmitting instructions to the ECUs 116 and receiving data or acknowledgment signals (e.g., after an ECU 116 receives an instructions, the ECU 116 may send a signal acknowledging receipt of the instructions, or may transmit data requested by the signal from the one or more processors 102). The data received by the ECU data reception module 200 may be used to determine whether communication has been lost with one or more of the ECUs 116, as discussed in further detail below.

The sensor data reception module 202 may receive data from the one or more vehicle sensors 110. The received sensor data may be used to determine a driver profile, as discussed in further detail below.

The ECU communication determination module 204 may determine whether communication has been lost with any of the ECUs 116, as disclosed herein. In one example, the ECU communication determination module 204 may determine that communication has been lost with an ECU 116 when the ECU data reception module 200 receives a signal (e.g., a DTC) from the ECU 116 indicating that the ECU 116 is shutting down. In other examples, the ECU communication determination module 204 may determine that communication has been lost with an ECU 116 when the ECU data reception module 200 has not received any data from the ECU 116 for more than a threshold period of time. In some examples, a user may set this threshold period of time.

The driver profile determination module 206 may determine a driver profile associated with a driver based on sensor data received by the sensor data reception module 202, as disclosed herein. When a particular driver drives a vehicle, the driver may utilize certain driving behaviors or vehicle settings or preferences in a consistent manner. For example, the driver may place his hands at a certain spot on the steering wheel, the driver may listen to a particular radio station, the driver may adjust the driver’s seat and mirrors to particular positions, or the driver may adjust the heating or air conditioning in the vehicle to particular settings, and the like. Other driving patterns that may be utilized may include drive time, geolocation, usage and/or connectivity of accessories (e.g., Bluetooth devices), presence of a vehicle’s key fob, shifting behavior (e.g., paddle shifting for automatic transmission, or gear shifting for manual transmission), driver’s vision on the road, respect to traffic signals, proximity to objects on the road, and usage of self-driving aids (e.g., lane departure, paring, speed regulation), among other driving patterns. All of this driving behavior and vehicle settings data for a particular driver may be aggregated into a driver profile associated with the driver. As such, a particular driver profile may indicate driving behaviors and vehicle settings of a particular driver.

In one example, a driver profile may comprise a set of driving behaviors or vehicle settings that indicate a likelihood that each such driving behavior or vehicle setting is associated with the driver. In one example, a driver profile may comprise a confidence interval for one or more driving behaviors or vehicle settings within which the likelihood of the driver’s behaviors or vehicle settings being within the confidence interval is above a threshold confidence level. For example, a confidence interval associated with a driver profile may comprise a range of temperatures for vehicle heating that is likely to be set by the driver with greater than a threshold level of confidence. For example, a driver profile associated with an example driver may indicate that there is a 95% likelihood that the driver will set the heating temperature to between 72° and 74°.

Thus, after a driver profile is established for a particular driver, any time the vehicle is driven, the driving behavior and vehicle settings of the driver may be compared to the driver profile. If the driving behavior and vehicle settings largely match the driver profile, it may be presumed that the driver associated with the driver profile is actually driving the vehicle. However, if the driving behavior and vehicle settings do not match the driver profile, this may indicate that a different driver is driving the vehicle. In particular, if the vehicle is stolen by a vehicle thief, the driving behavior and vehicle settings of the vehicle thief are unlikely to match the driver profile associated with the driver of the vehicle. Thus, the driver profile not matching the driving behavior and vehicle settings may indicate that the vehicle has been stolen, and an alert may be generated in certain circumstances, as discussed in further detail below.

The driver profile determination module 206 may determine a driver profile associated with a particular driver. In particular, the sensor data reception module 202 may receive data from the vehicle sensors 110 over a certain period of time, and the driver profile determination module 206 may determine a driver profile for the driver based on the received data. For example, the first time that the vehicle owner drives the vehicle (e.g., while driving the vehicle home from a dealership), the sensor data reception module 202 may collect such data, and the driver profile determination module 206 may determine the driver profile. In another example, the vehicle may have a setting that allows a driver to establish a driver profile. For example, the driver may enter a command in a vehicle head unit to establish a driver profile, and the vehicle head unit may request the driver to drive for a certain distance or a certain period of time (e.g., 20 minutes). During this time, the sensor data reception module 202 may receive sensor data from the vehicle sensors and the driver profile determination module 206 may determine the driver profile based on the sensor data received during this time.

In some examples, the driver profile determination module 206 may use one or more machine learning algorithms to determine the driver profile. In some examples, after an initial driver profile is established, the driver profile determination module 206 may update the driver profile as additional sensor data is collected during additional driving trips performed by the driver. In some examples, the driver profile determination module 206 may establish multiple driver profiles for multiple drivers.

A driver profile may include a variety of driving behaviors or vehicle settings, including, but not limited to, where the driver touches the steering wheel, the direction of the driver’s gaze while driving, the rate of acceleration or braking performed by the driver, the driver’s use of headlights, the throttle position used by the driver, the steering angle used by the driver, vehicle climate settings (e.g., temperature settings and use of heating and/or air conditioning), vehicle audio settings (e.g., audio volume or radio stations selected), mirror positions (e.g., rear-view mirror or side mirrors), use of windshield wipers, drive times (e.g., times of day that the driver drives the vehicle), geolocation data (e.g., locations where the driver drives the vehicle), connectivity of accessories (e.g., Bluetooth connections to the driver’s smartphone), presence of a key fob, how closely the driver follows other vehicles on the road, shifting behavior for manual transmission vehicles, usage of different types of vehicle assistance (e.g., lane keep assist), and vehicle access methods (e.g., use of a physical or digital key), among others.

The driver profile comparison module 208 may compare driving behaviors and vehicle settings during a particular driving trip to the driving behaviors and vehicle settings associated with a driver profile, as disclosed herein. As discussed above, a driver profile associated with a driver may comprise a set of driving behaviors and vehicle settings associated with that driver. Accordingly, during a driving trip of the vehicle, the sensor data reception module 202 may collect sensor data from the vehicle sensors 110, as discussed above. The driver profile comparison module 208 may then determine one or more driving behaviors and vehicle settings based on the received sensor data, and compare the determined driving behaviors and vehicle settings to the driving behaviors and vehicle settings associated with the driver profile.

In particular, for each driving behavior or vehicle setting associated with the driver profile, the driver profile comparison module 208 may measure the same driving behavior or vehicle setting of the current driving trip, based on the received sensor data, and compare the determined driving behavior or vehicle setting to the corresponding driving behavior or vehicle setting associated with the driver profile. The driver profile comparison module 208 may then determine whether each determined driving behavior or vehicle setting for the current driving trip matches the associated driving behavior or vehicle setting of the driver profile.

In some examples, for each determined driving behavior or vehicle setting, the driver profile determination module 206 may determine the probability that the driving behavior or vehicle setting is being performed or set by the driver matches a corresponding driving behavior or vehicle setting associated with the vehicle profile, using statistical methods. In some examples, as discussed above, for each driving behavior or vehicle setting, the driver profile may comprise a confidence interval of values having at least a predetermined confidence level of being associated with the driver. As such, in these examples, the driver profile determination module 206 may determine whether each driving behavior or vehicle setting is within the confidence interval associated with the driver profile. The vehicle system 100 may transmit an alert depending on the number of driving behaviors or vehicle settings that match the driver profile, as discussed in further detail below.

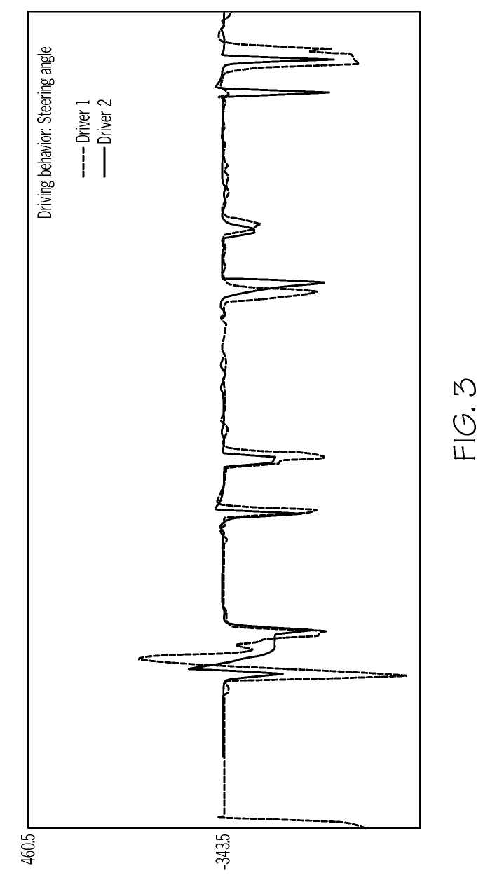

FIG. 3 shows example driving behavior data that may be analyzed by the driver profile determination module 206. In particular, FIG. 3 shows a plot of the steering angle used by two drivers obtained by the vehicle sensors 110 while the vehicle followed the same route. In the example of FIG. 3, driver 1 is a driver associated with a driver profile that has been determined by the driver profile determination module 206, and driver 2 is an unknown driver who is a potential thief. As can be seen in FIG. 3, while there is some difference between the data associated with driver 1 and driver 2, the differences are relative small. As such, in the example of FIG. 3, the driver profile determination module 206 may determine that there is a high probability that driver 2 is the same as driver 1. In other words, there is a low probability that driver 2 is a thief.

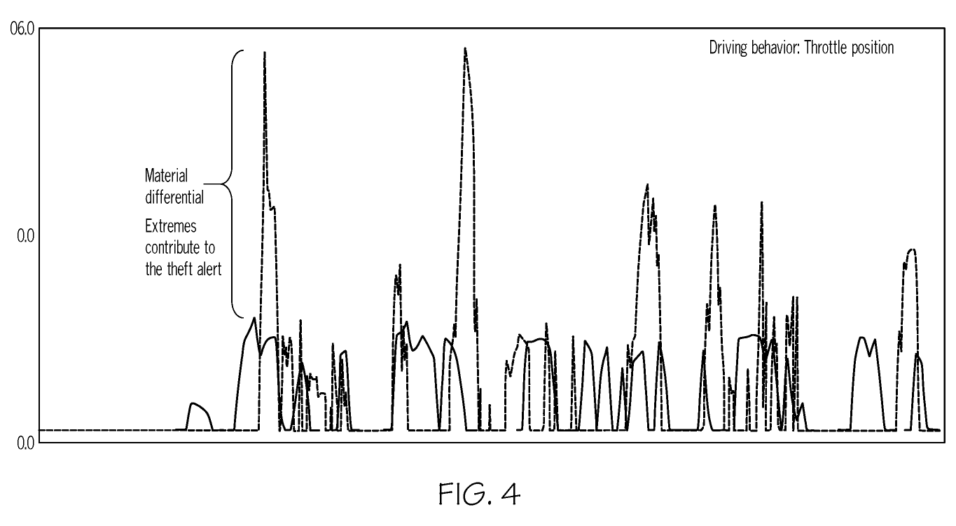

FIG. 4 shows additional example driving behavior data that may be analyzed by the driver profile determination module 206. In particular, FIG. 4 shows a plot of throttle position used by two drivers obtained by the vehicle sensors 110 while the vehicle followed the same route. In the example of FIG. 4, driver 1 is a driver associated with a driver profile that has been determined by the driver profile determination module 206, and driver 2 is an unknown driver who is a potential thief. As can be seen in FIG. 4, there is a substantial difference between the data associated with driver 1 and driver 2. As such, in the example of FIG. 4, the driver profile determination module 206 may determine that there is a low probability that the driver 2 is the same as driver 1. In other words, there is a high probability that driver 2 is a thief.

Referring back to FIG. 2, the alert determination module 210 may determine whether to transmit an alert based on the analysis performed by the ECU communication determination module 204 and the driver profile comparison module 208, as disclosed herein. In one example, the alert determination module 210 may determine whether to transmit an alert based on whether communication has been lost with one or more of the ECUs 116. In another example, the alert determination module 210 may determine whether to transmit an alert based on comparisons made by the driver profile comparison module 208. In another example, the alert determination module 210 may determine whether to transmit an alert based on a combination of whether communication has been lost with one or more of the ECUs 116 and comparisons made by the driver profile comparison module 208. These examples are discussed in further detail below.

In one example, the alert determination module 210 may determine whether to transmit an alert based on whether communication has been lost with one or more of the ECUs 116, as disclosed herein. In particular, as discussed above, the ECU communication determination module 204 may determine whether communication has been lost between the vehicle system 100 and one or more of the ECUs 116. More particularly, the ECU communication determination module 204 may determine how many ECUs 116 have lost communication with the vehicle system 100. In some examples, the ECU communication determination module 204 may determine how many ECUs 116 have lost communication with the vehicle system 100 during a predetermined period of time.

In embodiments, if communication has been lost between the vehicle system 100 and more than a predetermined number of the ECUs 116, the alert determination module 210 may determine that an alert should be transmitted. As discussed above, multiple ECUs shutting down at the same time may indicate that a vehicle E-theft (e.g., a CAN injection) is underway. As such, when communication has been lost between the vehicle system 100 and more than a threshold number of ECUs 116, this may indicate that an E-theft is underway, and the alert determination module 210 may determine that an alert should be transmitted.

In another example, the alert determination module 210 may determine whether to transmit an alert based on comparisons made by the driver profile comparison module 208, as disclosed herein. In particular, as discussed above, the driver profile determination module 206 may compare one or more driving behaviors or vehicle settings associated with a current driving trip to corresponding driving behaviors or vehicle settings associated with a driver profile (e.g., a driver profile associated with the vehicle owner). If the determined driving behaviors or vehicle settings associated with the current driving trip match the driver profile, it is likely that the driver associated with the driver profile is driving the vehicle, and the vehicle is not being stolen. However, if the determined driving behaviors or vehicle settings associated with the current driving trip do not match the driver profile, it is likely that someone other than the driver associated with the driver profile is driving the vehicle, which may indicate that the current driver is a thief. As such, the alert determination module 210 may determine that an alert should be transmitted in this situation.

In some examples, the driver profile comparison module 208 may determine how many of the determined driving behaviors or vehicle settings (associated with the current driving trip) do not match the corresponding driving behaviors or vehicle settings of the driver profile. In these examples, the alert determination module 210 may determine that an alert should be sent when more than a threshold number of the determined driving behaviors or vehicle settings do not match the driver profile. In some examples, a user may set this threshold number.

In some examples, as discussed above, the driver profile determination module 206 may determine a probability that each of the driving behaviors or vehicle settings determined for the current driving trip do not match the driver profile. In these examples, the alert determination module 210 may determine that each determined driving behavior or vehicle setting does not match the corresponding driving behavior or vehicle setting of the driver profile when the probability of there not being a match exceeds a threshold percentage. In some examples, a user may determine this threshold percentage.

In another example, the alert determination module 210 may determine whether to transmit an alert based on a combination of whether communication has been lost with one or more of the ECUs 116 and comparisons made by the driver profile comparison module 208, as disclosed herein. In particular, in some examples, the alert determination module 210 may determine that an alert should be sent if the ECU communication determination module 204 determines that communication has been lost between the vehicle system 100 and more than a threshold number of ECUs 116 and if the driving behaviors or vehicle settings of the current driving trip do not match a driver profile.

In some examples, if communication has been lost with a greater number of ECUs 116, then it may take a smaller number of driving behaviors or vehicle settings to not match a driver profile before the alert determination module 210 decides that an alert should be transmitted. Conversely, if communication has been lost with a smaller number of ECUs 116, then it may take a larger number of driving behaviors or vehicle settings to not match a driver profile before the alert determination module 210 decides that an alert should be transmitted. For example, if communication is lost with 4 or more ECUs, the alert determination module 210 may determine that an alert should be sent if as little as 2 driving behaviors or vehicle settings do not match a driver profile. Alternatively, if communication is lost with only 1 ECU, the alert determination module 210 may only determine that an alert should be sent if 6 or more driving behaviors or vehicle settings do not match a driver profile.

In some examples, if communication is lost with a significant number of ECUs 116 (e.g., more than a certain threshold), then the alert determination module 210 may determine that an alert should be sent regardless of how many driving behaviors or vehicle settings do not match the driver profile. Similarly, if a significant number of driving behaviors or vehicle settings do not match the driver profile, then the alert determination module 210 may determine that an alert should be sent regardless of how many ECUs have lost communication.

Referring still to FIG. 2 the alert transmission module 212 may transmit an alert. In some examples, the alert is transmitted to a device associated with an owner or authorized user of the vehicle (e.g., a text message, a pop-up notification through an app, an e-mail, a telephone call, and the like). In some examples, the alert is transmitted to a remote computing device (e.g., a cloud server or an edge server), and the remote computing device then transmits an alert to a device associated with the owner or authorized user of the vehicle.

In embodiments, the alert transmission module 212 may transmit an alert indicating a possible vehicle theft. For example, the alert may comprise text, graphics, images, or other information to indicate that a vehicle theft may be occurring, so that the user receiving the alert can take appropriate action. In some examples, before sending an alert, the alert transmission module 212 may first send a message to an app on the vehicle owner’s smartphone asking if they are currently driving the vehicle. If the vehicle owner answers yes, then the alert transmission module 212 will not send a theft alert.

If the vehicle owner answers no, then the alert transmission module 212 may send a message to the vehicle owner asking if the vehicle is being driven by an authorized driver. If the vehicle owner answers yes, then the alert transmission module 212 may transmit a message asking if the vehicle owner would like to add the user as an authorized driver. If the vehicle owners answers yes, then driver profile determination module 206 may learn a new driver profile for the current driver based on sensor data received by the sensor data reception module 202.

If the vehicle owners answers that they are not driving the vehicle and the vehicle is not being driven by an authorized driver, then the alert transmission module 212 may transmit the message indicating possible vehicle theft. In some examples, the alert transmission module 212 may also transmit a message to law enforcement indicating the possible vehicle theft.

In some examples, the alert transmission module 212 may send different alerts depending on the likelihood of vehicle theft. For example, if there is a lower probability of vehicle theft, then the alert transmission module 212 may only transmit a message over an app to the vehicle owner. However, if there is a larger probability of vehicle theft, then the alert transmission module 212 may transmit a message over the app and send a text and/or e-mail alert.

The probability of vehicle theft may be determined based on the number of ECUs having lost communication and/or the number of driving behaviors or vehicle settings that do not match the driver profile. For example, if the number of ECUs 116 having lost communication and/or the number of driving behaviors or vehicle settings that do not match the driver profile is between a first threshold and a second threshold, the alert transmission module 212 may only send a message over the app. However, if the number of ECUs 116 having lost communication and/or the number of driving behaviors or vehicle settings that do not match the driver profile is above the second threshold, the alert transmission module 212 may send a message over the app along with text and/or e-mail alerts. In some examples, the text of the alert transmitted by the alert transmission module 212 may change based on the probability of vehicle theft.

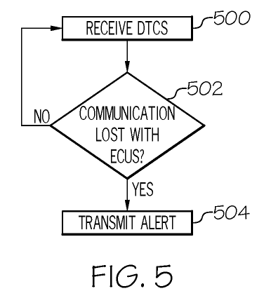

FIG. 5 depicts a flowchart of an example method of operating the vehicle system 100 to perform advanced vehicle theft alert, as disclosed herein. At step 500, the ECU data reception module 200 receives diagnostic trouble codes from the ECUs 116. At step 502, the ECU communication determination module 204 determines whether communication has been lost with one or more of the ECUs 116, using the techniques discussed above. If the ECU communication determination module 204 determines that communication has not been lost with one or more of the ECUs 116 (No at step 502), then control returns to step 500. Alternatively, if the ECU communication determination module 204 determines that communication has been lost with one or more of the ECUs 116 (Yes at step 502), then at step 504, the alert transmission module 212 transmits an alert.

In some examples, in addition to or instead of transmitting the alert, the vehicle system 100 may perform other actions to mitigate potential theft of the vehicle. For example, in addition to transmitting the alert when vehicle theft is suspected, the vehicle system 100 may turn off the vehicle, limit the speed of the vehicle, turn on the vehicle hazard lights, change the vehicle to autonomous driving mode, transmit the location of the vehicle, and the like. These operations may limit the ability of vehicle thieves to steal the vehicle and/or monitor the location of the vehicle so that it can be recovered in the event the vehicle is being stolen.

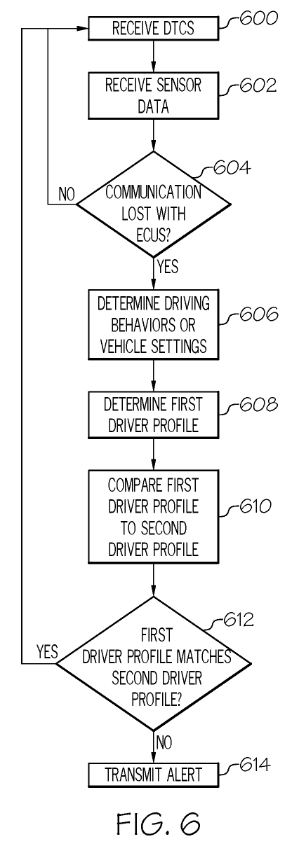

FIG. 6 depicts a flowchart of another example method of operating the vehicle system 100 to perform advanced vehicle theft alert, as disclosed herein. At step 600, the ECU data reception module 200 receives diagnostic trouble codes from the ECUs 116. At step 602, the sensor data reception module 202 receives sensor data from the vehicle sensors 110. At step 604 the ECU communication determination module 204 determines whether communication has been lost with one or more of the ECUs 116, using the techniques discussed above. If the ECU communication determination module 204 determines that communication has not been lost with one or more of the ECUs 116 (No at step 604), then control returns to step 600. Alternatively, if the ECU communication determination module 204 determines that communication has been lost with one or more of the ECUs 116 (Yes at step 604), then control passes to step 606.

At step 606, the driver profile determination module 206 determines a plurality of driving behaviors or vehicle settings based on the received sensor data. At step 608, the driver profile determination module 206 determines a first driver profile based on the determined driving behaviors or vehicle settings. At step 610, the driver profile comparison module 208 performs a comparison between the first driver profile and a second driver profile. The second driver profile may be associated with the vehicle owner.

At step 612, the driver profile comparison module 208 determines whether the first driver profile matches the second driver profile based on the comparison, using the techniques discussed above. If the driver profile comparison module 208 determines that the first driver profile matches the second driver profile (Yes at step 612), then control returns to step 600. Alternatively, if the driver profile comparison module 208 determines that the first driver profile does not match the second driver profile (No at step 612) , then at step 614, the alert transmission module 212 transmits an alert.

It should now be understood that embodiments described herein are directed to a method and system for advanced vehicle theft alert. A vehicle system may analyze communications data from a plurality of ECUs of a vehicle to determine whether communication has been lost with any of the ECUs. The vehicle system may also analyze driving behaviors or vehicle settings used during a driving trip and perform a comparison with a previously learned driver profile. By combination these two evaluations, the vehicle system may identify when a vehicle theft is likely occurring. The vehicle system may be particularly helpful in identifying E-theft such as a CAN injection. The vehicle system may then transmit an alert to the vehicle owner. This may allow the vehicle owner to become aware of a vehicle theft that they may otherwise have been unaware of, allowing the vehicle owner to quickly contact law enforcement or take other action to prevent the vehicle from being successfully stolen.

It is noted that the terms "substantially" and "about" may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method comprising:
receiving, at a vehicle system, diagnostic trouble codes (DTCs) from a plurality of electronic control units (ECUs) associated with the vehicle system;
determining whether communication has been lost between the vehicle system and one or more of the ECUs; and
upon determination that communication has been lost between the vehicle system and more than a first predetermined threshold number of the ECUs, transmitting an alert.

2. The method of claim 1, further comprising transmitting the alert to a user associated with the vehicle system.

3. The method of claim 1, further comprising transmitting the alert to a remote computing device.

4. The method of claim 1, further comprising determining that communication has been lost between the vehicle system and a first ECU of the one or more of the ECUs when the vehicle system has not received any DTCs from the first ECU for more than a threshold period of time.

5. A method comprising:
receiving, at a vehicle system, DTCs from a plurality of ECUs associated with the vehicle system;
receiving, at the vehicle system, sensor data from one or more vehicle sensors;
determining whether communication has been lost between the vehicle system and one or more of the ECUs; and
upon determination that communication has been lost between the vehicle system and more than a first predetermined threshold number of the ECUs:
determining a plurality of driving behaviors or vehicle settings based on the sensor data;
determining a first driver profile based on the determined plurality of driving behaviors or vehicle settings;
performing a comparison between the first driver profile and a second driver profile;
determining whether the first driver profile matches the second driver profile based on the comparison; and
upon determination that the first driver profile does not match the second driver profile, transmitting an alert.

6. The method of claim 5, further comprising determining that communication has been lost between the vehicle system and a first ECU of the one or more of the ECUs when the vehicle system has not received any DTCs from the first ECU for more than a threshold period of time.

7. The method of claim 5, further comprising:
performing a second comparison between each of the driving behaviors or vehicle settings associated with the first driver profile and associated driving behaviors or vehicle settings associated with the driver profile;
determining whether greater than a predetermined number of the driving behaviors or vehicle settings associated with the first driver profile do not match corresponding driving behaviors or vehicle settings associated with the second driver profile based on the second comparison; and
upon determination that greater than the predetermined number of the driving behaviors or vehicle settings associated with the first driver profile do not match the corresponding driving behaviors or vehicle settings associated with the second driver profile, determining that the first driver profile does not match the second driver profile.

8. The method of claim 7, further comprising:
for each of the driving behaviors or vehicle settings associated with the first driver profile, determining a probability that the driving behavior or vehicle setting does not match the corresponding driving behavior or vehicle setting associated with the second driver profile; and
upon determination that the determined probability is greater than a threshold probability, determining that the driving behavior or vehicle setting associated with the first driver profile does not match the corresponding driving behavior or vehicle setting associated with the second driver profile.

9. The method of claim 8, further comprising, receiving the threshold probability from a user.

10. The method of claim 5, further comprising:
receiving second sensor data from the one or more vehicle sensors while a first user drives the vehicle; and
determining the second driver profile based on the second sensor data.

11. The method of claim 5, wherein the driving behaviors comprise one or more of steering wheel hand position, driver gaze direction, a rate of vehicle acceleration, a rate of vehicle braking, headlight usage, throttle position, steering angle, windshield wiper usage, drive times, geolocation data, vehicle following distances, shifting behavior, and use of vehicle assistance.

12. The method of claim 5, wherein the vehicle settings comprise one or more of climate settings, audio settings, mirror position, seat position, connectivity of accessories, presence of a key fob, and vehicle access methods.

13. A vehicle system comprising one or more processors configured to:
receive DTCs from a plurality of ECUs associated with the vehicle system;
receive sensor data from one or more vehicle sensors;
determine whether communication has been lost between the vehicle system and one or more of the ECUs; and
upon determination that communication has been lost between the vehicle system and more than a first predetermined threshold number of the ECUs:
determine a plurality of driving behaviors or vehicle settings based on the sensor data;
determine a first driver profile based on the determined plurality of driving behaviors or vehicle settings;
perform a comparison between the first driver profile and a second driver profile;
determine whether the first driver profile matches the second driver profile based on the comparison; and
upon determination that the first driver profile does not match the second driver profile, transmit an alert.

14. The vehicle system of claim 13, wherein the one or more processors are further configured to determine that communication has been lost between the vehicle system and a first ECU of the one or more of the ECUs when the vehicle system has not received any DTCs from the first ECU for more than a threshold period of time.

15. The vehicle system of claim 13, wherein the one or more processors are further configured to:
perform a second comparison between each of the driving behaviors or vehicle settings associated with the first driver profile and associated driving behaviors or vehicle settings associated with the driver profile;
determine whether greater than a predetermined number of the driving behaviors or vehicle settings associated with the first driver profile do not match corresponding driving behaviors or vehicle settings associated with the second driver profile based on the second comparison; and
upon determination that greater than the predetermined number of the driving behaviors or vehicle settings associated with the first driver profile do not match the corresponding driving behaviors or vehicle settings associated with the second driver profile, determine that the first driver profile does not match the second driver profile.

16. The vehicle system of claim 15, wherein the one or more processors are further configured to:
for each of the driving behaviors or vehicle settings associated with the first driver profile, determine a probability that the driving behavior or vehicle setting does not match the corresponding driving behavior or vehicle setting associated with the second driver profile; and
upon determination that the determined probability is greater than a threshold probability, determine that the driving behavior or vehicle setting associated with the first driver profile does not match the corresponding driving behavior or vehicle setting associated with the second driver profile.

17. The vehicle system of claim 16, wherein the one or more processors are further configured to receive the threshold probability from a user.

18. The vehicle system of claim 13, wherein the one or more processors are further configured to:
receive second sensor data from the one or more vehicle sensors while a first user drives the vehicle; and
determine the second driver profile based on the second sensor data.

19. The vehicle system of claim 13, wherein the driving behaviors comprise one or more of steering wheel hand position, driver gaze direction, a rate of vehicle acceleration, a rate of vehicle braking, headlight usage, throttle position, steering angle, windshield wiper usage, drive times, geolocation data, vehicle following distances, shifting behavior, and use of vehicle assistance.

20. The vehicle system of claim 13, wherein the vehicle settings comprise one or more of climate settings, audio settings, mirror position, seat position, connectivity of accessories, presence of a key fob, and vehicle access methods.
